(19) United States
(12) Patent Application Publication
(10) Pub. No.: US 2011/0174586 A1
(43) Pub. Date: Jul. 21, 2011

(54) LOW LOSS SYNCHRONIZATION KEY

(75) Inventor: Mikael WESTERBERG, Vaenersborg (SE)

(73) Assignee: GM GLOBAL TECHNOLOGY OPERATIONS LLC, Detroit, MI (US)

(21) Appl. No.: 13/009,415

(22) Filed: Jan. 19, 2011

(30) Foreign Application Priority Data
Jan. 19, 2010 (GB) 1000795.3

(51) Int. Cl. F16D 23/02

(52) U.S. Cl. 192/53.32

(57) ABSTRACT

A synchronizer assembly is provided for a gearbox of a power train of a vehicle. The synchronizer assembly includes, but is not limited to a synchronizer hub, one or more axially movable synchronizer rings, an axially movable synchronizer sleeve, and a synchronizer key. The synchronizer hub is intended for engaging with a shaft of the gearbox. The axially movable synchronizer rings include, but are not limited to synchronizer frictional surfaces for frictional engagement with gearwheel frictional surfaces of gearwheels of the gearbox. The axially movable synchronizer sleeve is intended for engaging with the synchronizer hub and with the synchronizer rings. The synchronizer key is arranged between the synchronizer hub and the synchronizer sleeve. The synchronizer key comprises one or more release members for engaging the synchronizer rings in an axial direction such that the synchronizer rings are movable away from the gearwheel frictional surfaces of the gearwheels of the gearbox.

### CROSS-REFERENCE TO RELATED APPLICATION

This application claims priority to British Patent Application No. 1000795.3, filed Jan. 19, 2010, which is incorporated herein by reference in its entirety.

### TECHNICAL FIELD

The technical field relates to an improved synchronizer for an engine transmission and in particular to an improved synchronization key of the synchronizer.

### BACKGROUND

A type of gear transmission is used for transferring torque of a combustion engine to driving wheels of a vehicle. The transmission includes an input shaft and an output shaft. The input shaft is used for connecting to the engine by way a clutch whilst the output shaft is used for connecting to the wheels. The input shaft carries input gearwheels that are fixed to the input shaft. In contrast, the output shaft carries output gearwheels that are rotatable about the output shaft. The input gearwheels mesh or comb with the output gearwheel to transfer the engine torque to the wheels. The output shaft also carries synchronizers for allowing the transmission to have different torque paths for providing various gearshifts.

In view of the foregoing, at least one object is to provide an improved engine transmission with a low operating cost. The operating cost can be kept low when wear of the synchronizer, which is also called a synchronizer, is reduced. In addition, other objects, desirable features and characteristics will become apparent from the subsequent summary and detailed description, and the appended claims, taken in conjunction with the accompanying drawings and this background.

### SUMMARY

The application provides an improved synchronizer for an idler gearwheel of an engine transmission. The idler gearwheel is rotatable about a shaft of the transmission. The synchronizer is fixed to the shaft. The synchronizer includes a friction member for synchronizing a rotating speed of the idler gearwheel to a rotating speed of the shaft. The speed synchronization relates to eliminating a speed difference between the gearwheel and the shaft for enabling a smooth interlocking between the shaft and the gearwheel.

One of the main thoughts of the application is that the synchronizer is improved when a synchronization key of the synchronizer is adapted to hold the synchronizer friction member away from the gearwheel when the synchronizer is disengaging from the idler gearwheel. The synchronizer key is also called a pre-synchronization key. This is unlike other synchronizer that does not position the friction member away from the idler gearwheel during the disengagement but let the friction member grind or rub against the gearwheel during the disengagement.

It is believed that this synchronizer key can allow the synchronizer and the friction member to have a low loss or low wear. One of the major loss mechanisms of transmissions relates to the friction member dragging or grinding against the gearwheel. This in turn generates quality issues due to the resulting wear and to the corresponding energy dissipation. The application thus benefits from avoiding this loss mechanism.

The application provides a synchronizer assembly for a gearbox or transmission of a power train of a vehicle. The gearbox comprises a shaft and one or more idler gearwheels that are provided on the shaft such that the gearwheels are rotatable about the shaft. The idler gearwheels can rotate about the shaft at speeds that are different from a rotation speed of the shaft.

The synchronizer assembly is used for synchronizing rotational speeds of the gearwheels to the rotational speed of the shaft. The synchronization refers to eliminating differences of rotational speeds between the gearwheels and the shaft. The speed synchronization allows smooth interlocking between the gearwheels and the shaft. The synchronizer assembly includes a synchronizer hub, one or more synchronizer rings, a synchronizer key, and a synchronizer sleeve. The synchronizer rings are also called synchronizer cones. In particular, the synchronizer hub is used for mechanically engaging with the shaft of the gearbox such that the synchronizer hub and the shaft are rotatable about an axis of the shaft at the same speed. The axis is a reference for “axially” in the following description.

The synchronizer rings are arranged next to the synchronizer hub as well as being arranged between the synchronizer hub and the gearwheels. The synchronizer rings include synchronizer frictional surfaces for frictional engagement with gearwheel frictional surfaces of the gearwheels of the gearbox. The frictional engagement is intended for forcing the gearwheels to rotate at the same speed as the synchronizer rings.

The synchronizer sleeve is axially moveable and it is used for mechanically engaging with the synchronizer hub and with the synchronizer rings. The engagement allows the synchronizer sleeve, the synchronizer hub, and the synchronizer rings to be rotatable together about the shaft at the same speed. The axial movement of the synchronizer sleeve enables the synchronizer sleeve to actuate the synchronizer rings for forcedly engaging with the gearwheels. In practice, a user can use a lever for actuating the synchronizer sleeve.

The synchronizer key is arranged or is disposed between the synchronizer hub and the synchronizer sleeve. The synchronizer key often is used for a transmission of torque between the synchronizer sleeve and the synchronizer ring but this is an alternative or an additional function. Further, the synchronizer key comprises one or more release members for mechanically engaging the synchronizer rings in an axial direction such that the synchronizer rings are movable away from the gearwheel frictional surfaces of the gearwheels of the gearbox when the synchronizer assembly is disengaged from the gearwheels. This differs from other synchronizer assembly that does not move or urge the synchronizer rings away from the gearwheels during the disengagement but let the synchronizer rings to drag or rub against the gearwheels. This thus benefits the synchronizer assembly in reducing wear of the synchronizer rings. In addition, the synchronizer sleeve, the synchronizer hub, and the synchronizer rings are rotatable together about the shaft at a same speed.

The synchronizer sleeve can also include a bump for actuating the synchronizer rings via the synchronizer key to engage with the gearwheels. The synchronizer sleeve can also include splines for mechanically engaging with the synchronizer hub and with the synchronizer rings. A lever that is controlled by a user can actuate the synchronizer sleeve. The lever allows easier access to the synchronizer sleeve.

The holding member can comprise a spring section, such as curved metal, for urging the synchronizer rings away from the gearwheel and towards the synchronizer hub when the synchronizer assembly is disengaged from the gearwheel. The spring section allows easier implementation of the urging action.

The spring section can comprise one or more claw portions that are retained by one or more respective grooves of the synchronizer rings. The claws act to hold the synchronizer rings for urging the synchronizer rings away from the gearwheels when the synchronizer assembly is mechanically disengaging from the gearwheel. Furthermore, the spring section can also comprise a middle portion for disposing on the synchronizer hub. The spring section can comprise one or more portions that are produced by machine punching. One or more other portions of the spring section can also be bent. The punching and bending allows the spring section to be formed for performing the above-mentioned functions of urging.

The synchronizer assembly can include different number of synchronizer rings for different purposes. In one implementation, the synchronizer assembly includes just one synchronizer ring for selectively frictional engagement with one gearwheel. This kind of synchronizer assembly is known as a single-acting synchronizer or a single-sided synchronizer. In another implementation, the synchronizer assembly includes two synchronizer rings for selectively frictional engagement with two gearwheels. This kind of synchronizer assembly is known as a two-acting synchronizer or a two-sided synchronizer. Functionally, two single-sided synchronizers can the functions of one two-sided synchronizer. Put differently, two single-sided synchronizers can replace one two-sided synchronizer.

The friction members of the synchronizer rings can comprise an internal frustoconical surfaces that are adapted for frictional engagement with an external frustoconical surfaces of the gearwheel friction members. The frustoconical surfaces have a shape of partial cone. The internal frustoconical surfaces and the synchronizer rings can share a same axis of rotation. Similarly, the external frustoconical surfaces and the gearwheels can share a same axis of rotation. The frustoconical surfaces have an advantage of simple design and deployment.

The synchronizer hub can be fixed to the shaft via means of splines such that the synchronizer hub is slidable in an axial direction of the shaft. This can enable the synchronizer key to move in an axial direction of the shaft in an easier manner.

One possible method of installing the synchronizer assembly onto the shaft of the transmission includes a step of fixing the synchronizer hub onto the shaft. After this, the synchronizer rings are positioned next to the synchronizer hub. The synchronizer key is then placed on the synchronizer hub with the synchronizer key holding the synchronizer rings. After this, the synchronizer sleeve is moved into position such that a recess of the sleeve is splined with the synchronizer hub and with the synchronizer rings and the synchronizer key being compressible when the synchronizer sleeve slides over the synchronizer key.

One possible way of operating the synchronizer assembly comprises a step of selecting one gearwheel for synchronizing with the shaft. The selected gearwheel is located next to the synchronizer assembly.

A user then actuates the synchronizer sleeve towards the selected gearwheel. The synchronizer sleeve in turn moves the synchronizer key towards the selected gearwheel. This action also causes the synchronizer key to push the associated synchronizer ring towards the selected gearwheel for forcing the selected gearwheel to rotate at the same rotational speed as the associated synchronizer ring. After this, a dog clutch of the selected gearwheel can smoothly interlock the selected gearwheel with the shaft via the synchronizer assembly.

Later, when the interlocking is not required, the user moves the synchronizer sleeve away from the engaged gearwheel. This in turn moves the synchronizer key that holds or moves the associated synchronizer ring away from the engaged gearwheel. The holding away of the associated synchronizer ring prevent the associated synchronization ring from dragging or rubbing against the gearwheel, which advantageously reduces wear of the synchronization ring.

The application provides a shifting mechanism for an engine transmission. The shifting mechanism comprises the above synchronizer assembly and one or more gearwheels. The more gearwheels include dog clutches for interlocking the respective gearwheels to a shaft of the transmission after rotational speeds of the gearwheels are synchronized with a rotational speed of the shaft. This interlocking allows a torque of the shaft to be transmitted to the said gearwheels. The application also provides a gearbox or transmission for an engine of a vehicle.

The transmission is used for providing different gear ratios whilst the engine is used for converting electrical power or fuel to mechanical movements. The transmission comprises a driving shaft, one or more driving gearwheels, and one or more of the above-mentioned shifting mechanisms. The driving shaft is intended for connecting to a powertrain section of a vehicle that includes one or more wheels. The driving gearwheels are rotatably mounted on the driving shaft. The shifting mechanisms are mounted on the driving shaft for selectively engaging the driving gearwheels with the driving shaft.

The transmission can further comprise an input shaft and one or more input gearwheels that are mounted fixedly on the input shaft. The input shaft can be parallel to the driving shaft and it is intended for selective engagement with an engine via a clutch. The input gearwheels engage or mesh constantly with the driving gearwheels to transfer rotational movement of the input shaft to the driving shaft.

The application provides a powertrain and a vehicle for transporting goods or people. The powertrain comprises a combustion engine and the above-mentioned transmission being engaged selectively to the combustion engine. The vehicle comprises one or more wheels and the powertrain that is connected to the wheels.

To summarize, a gearwheel assembly includes gearwheels, synchronizer cones, and dog clutch rings are attached to each other such that they have the same rotational speed. The application provides an improved synchronizer assembly that comprises synchronizer rings, a synchronizer hub, an improved synchronizer key, and a synchronizer sleeve that are attached to each other such that they always have the same rotational speed. The synchronizer assembly can be fixed to a rotational shaft of a transmission by means of a spline connection. The synchronizer sleeve is engaged to the synchronizer ring and the synchronizer hub by means of a spline connection.

In practice, when the gearwheels are disengaged, a rotational speed difference between the friction cone and the synchronizer ring can exist. The gearwheels engage smoothly with the synchronizer assembly. The synchronizer assembly reduces and eliminates any rotational speed difference that exists between the synchronizer ring and the associated friction cone. This is achieved by moving the synchronizer sleeve an axially direction of the shaft toward the selected gearwheel. This movement in turn pushes the synchronizer key that also pushes the corresponding synchronizer ring against the associated friction cone. This results in bringing the gear assembly to the same rotational speed as the rotational shaft. Torque and speed is then transferred from the rotational shaft through the synchronizer hub to the synchronizer sleeve to the associated dog clutch by means of their respective spline connection. When the engagement between the selected gearwheel and synchronizer assembly is not required, the synchronizer sleeve is then moved away from the selected gearwheel. This in turn causes the synchronizer key to hold the associated synchronizer ring away from the corresponding friction cone to avoid advantageously unwanted wear and friction.

### BRIEF DESCRIPTION OF THE DRAWINGS

The present invention will hereinafter be described in conjunction with the following drawing figures, wherein like numerals denote like elements, and.

FIG. 1 illustrates a cross-sectional view of an improved transmission;

FIG. 2 illustrates an improved synchronizer of the transmission of FIG. 1;

FIG. 3 illustrates a first step of assembling the synchronizer of FIG. 2;

FIG. 4 illustrates a second step of assembling the synchronizer of FIG. 2;

FIG. 5 illustrates a third step of assembling the synchronizer of FIG. 2;

FIG. 6 illustrates a fourth step of assembling the synchronizer of FIG. 2;

FIG. 7 illustrates symbols for a double-sided coupling device;

FIG. 8 illustrates symbols for a single-sided coupling device;

FIG. 9 illustrates symbols for an idler gearwheel which is supported rotatably on a shaft;

FIG. 10 illustrates symbols for a fixed gearwheel which is supported on a shaft; and

FIG. 11 illustrates one embodiment of powertrain that comprises the improved synchronizer of FIG. 2.

### DETAILED DESCRIPTION

The following detailed description is merely exemplary in nature and is not intended to limit application and uses. Furthermore, there is no intention to be bound by any theory presented in the preceding background or summary or the following detailed description. The figures described below have similar parts. The similar parts have same names or same part numbers. The description of the similar parts is hereby incorporated by reference, where appropriate, thereby reducing repetition of text without limiting the disclosure.

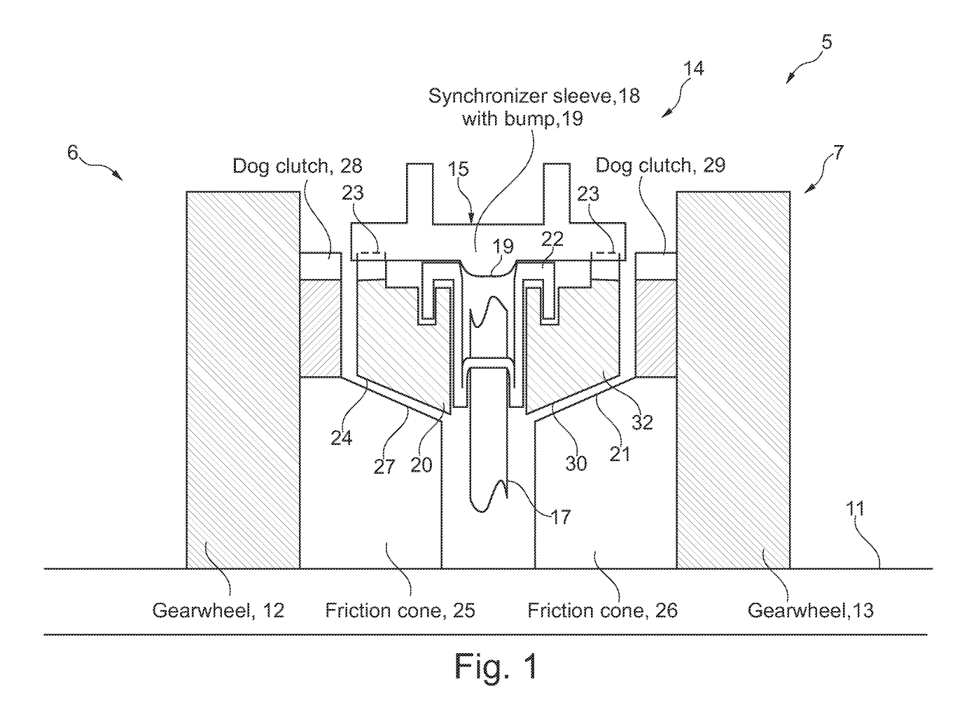

FIG. 1 shows a transmission 5 that includes a driving shaft 11, a first gearwheel assembly 6, a second gearwheel assembly 7, and a shifting mechanism 14. The shifting mechanism 14 comprises an improved synchronizer mechanism 15. The driving shaft 11 is also called a layshaft or an output shaft.

The first gearwheel assembly 6, the second gearwheel assembly 7, and the synchronizer mechanism 15 are mounted on the driving shaft 11, wherein the synchronizer mechanism 15 is positioned between the first gearwheel assembly 6 and the second gearwheel assembly 7. In particular, the driving shaft 11 is rotatably mounted about a shaft axis. The first gearwheel assembly 6 and the second gearwheel assembly 7 are axially spaced apart and are rotatably about the driving shaft 11.

The synchronizer mechanism 15 is fixed to the driving shaft 11 by means of splines such the synchronizer mechanism 15 and the driving shaft 11 are rotatable about the shaft axis at the same speed. The spline connection allows the synchronizer mechanism 15 to slide in an axial direction of the driving shaft 11 for selectively engaging the first gearwheel assembly 6 and the second gearwheel assembly 7.

Referring to the gearwheel assembly 6, it includes a gearwheel 12 as well as a dog clutch 28 and a first cone portion 25, both of which are fixed to the gearwheel 12. These said parts are fixed or are attached to each other such that they have the same rotational speed about the driving shaft 11. The first cone portion 25 is also called a friction cone or a synchronizer cup. The gearwheel 12 is also called as a gear whilst the dog clutch 28 is also called a dog clutch ring.

The first gearwheel 12 has teeth around its edges for mechanically engaging other gearwheels Annular thrust members on the driving shaft 11 secure against movement of the first gearwheel 12 in an axial direction of the driving shaft 11. The said thrust members are retained axially in annular grooves that are provided on the driving shaft 11. The thrust members and the annular grooves are not shown in the FIG. 1.

The dog clutch 28 includes a number of teeth that are used for selectively interlocking the synchronizer mechanism 15 such that the output gearwheel 12 rotates at the same speed as the output shaft 11. The interlocking is intended for transmitting a rotating torque of the shaft to the gearwheel 12 via the synchronizer mechanism 15. Similarly, the gearwheel assembly 7 includes a gearwheel 13 as well as a dog clutch 29 and a second cone portion 26, both of which are fixed to the gearwheel 13.

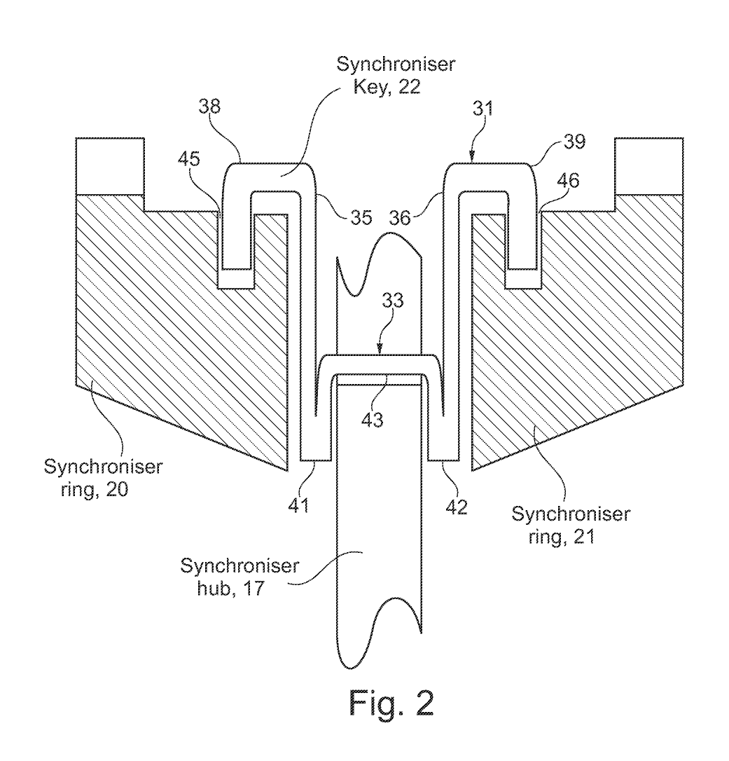

As better seen in FIG. 2, the synchronizer mechanism 15 includes a synchronizer hub 17, an improved synchronizer key 22, a first synchronizer ring 20, a second synchronizer ring 21, and a synchronizer sleeve 18. These said parts of the synchronizer mechanism 15 are attached to each other such that they are rotatable together about the driving shaft 11 at the same speed. The synchronizer hub 17 is fixed to the driving shaft 11 such that the synchronizer hub 17 and the driving shaft 11 are rotatable about the driving shaft 11 at the same speed. In a special embodiment, the synchronizer hub 17 is fixed to the driving shaft 11 by means of splines. The splines allow the synchronizer hub 17 to be moveable in an axial direction of the shaft 11. The splines refer to multiple projections or protrusions of one part for fitting into slots of another part. The projections and the slots are not shown in the FIG. 1 for sake of simplicity.

The synchronizer key 22 is placed on the synchronizer hub 17 and it interlocks with the synchronizer hub 17 such that the synchronizer key 22 and the synchronizer hub 17 are rotatable about the shaft 11 at the same speed. The synchronizer key 22 is also moveable in an axial direction of the shaft 11. In addition, the synchronizer key 22 holds the first synchronizer ring 20 and the second synchronizer ring 21. The holdings allows the synchronizer key 22 to urge the synchronizer rings 20 and 21 towards the synchronizer key 22, when the synchronizer key 22 is actuated by the synchronizer sleeve 18 in the axial direction of the shaft 11.

The first synchronizer ring 20 has a first inner peripheral surface 24 that is tapered or that is adapted to engage frictionally with a first cone surface 27 of the first cone portion 25 of the first gearwheel 12. Similarly, the second synchronizer ring 21 has a second inner peripheral surface 30 that is tapered or that is adapted to engage frictionally with a second cone surface 32 of the second cone portion 26 of the second gearwheel 13.

A central portion of the synchronizer sleeve 18 has a sleeve-bump 19 whilst other parts of the synchronizer sleeve 18 have recesses 23, which include splines. The splines are not shown in the FIG. 1. The sleeve splines engages with slots of the synchronizer hub 17 and with slots of the synchronizer rings 20 and 21 such that the synchronizer sleeve 18, the synchronizer rings 20 and 21, and the synchronizer hub 17 allow rotate together about the driving shaft 11 at the same rotational speed. The slots are not shown in FIG. 1. The sleeve splines also enable the synchronizer sleeve 18 to be moveable in the axial direction of the shaft 11 whilst the sleeve recesses 23 and the sleeve splines compress the synchronizer key 22. The sleeve-bump 19 abuts the synchronizer key 22 for actuating the synchronizer key 22.

The synchronizer hub 17 and the synchronizer sleeve 18 comprise mainly of steel, but the first and the second synchronizer rings 20 and 21 is made of a softer material, such as brass, to reduce wear of the first and the second cone portions 25 and 26.

Referring to FIG. 2, the synchronizer key 22 includes a spring 31 to hold the first synchronizer ring 20 and the second synchronizer ring 21 towards the synchronizer hub 17. The spring 31 comprises a u-shaped section 33 that is connected integrally to a first straight section 35 and to a second straight section 36. The first straight section 35 is connected integrally to a first claw 38 whilst the second straight section 36 is connected integrally to a second claw 39. In particular, the u-shaped section 33 has a first end 41 and a second end 42, as well as a middle portion 43. One end of first straight section 35 is connected integrally to the first end 41 whilst another end of the first straight section 35 is connected integrally to the first claw 38. In a similar manner, one end of second straight section 36 is connected integrally to the second end 42 whilst another end of the second straight section 36 is connected integrally to the second claw 39.

The middle portion 43 interlocks with the synchronizer hub 17 such that the synchronizer key 22 and the synchronizer hub 17 are rotatable about the shaft 11 at the same speed. One end of the first claw 38 is retained in a groove 45 of the first synchronizer ring 20 for holding the first synchronizer ring 20 to urge the first synchronizer ring 20 toward the synchronizer key 22 when the synchronizer sleeve 18 actuates the synchronizer key 22. Similarly, one end of the second claw 39 is retained in a groove 46 of the second synchronizer ring 21 for holding the second synchronizer ring 20 to urge the second synchronizer ring 21 toward the synchronizer key 22 when the synchronizer sleeve 18 actuates the synchronizer key 22.

The sleeve bump 19 of the synchronizer sleeve 18 abuts the first claw 38 and the second claw 39 of the synchronizer key 22 for actuating the synchronizer key 22. To produce the spring 31, one possible way is to use metal stamping. The stamping can include steps of punching with a machine press and steps of bending.

Functionally, when the gearwheels 12 and 13 are disengaged from the synchronizer mechanism 15, the gearwheels 12 and 13, and the shaft 11 can rotate at different speeds. In contrast, when the gearwheel 12 or 13 is engaged with the synchronizer mechanism 15, the engaged gearwheel 12 or 13 rotates at the same speed as the shaft 11.

The synchronizer mechanism 15 is used for synchronizing rotating speed between the selected gearwheel 12 or 13 and the shaft 11. In addition, the synchronizer mechanism 15 prevents a coupling or an engaging of the driving shaft 11 to a selected gearwheel 12 or 13 until the selected gearwheel 12 or 13 is brought to a synchronous rotation with the driving shaft 11. A coupling of the driving shaft 11 to the selected gearwheel 12 or 13 when these parts are rotating at different speeds would result in noise being generated with the said part being damaged.

The first synchronizer ring 20 and the first cone portion 25 act as friction members of a first friction clutch for synchronizing rotational speed of the first gearwheel 12 to the rotational speed of the driving shaft 11. Likewise, the second synchronizer ring 21 and the second cone portion 26 act as friction members of a second friction clutch for synchronizing rotational speed of the second gearwheel 13 to the rotational speed of the driving shaft 11.

Different types of friction clutches may also be used. The friction members may be affixed to the associated gearwheels 12 or 13 in a number of ways. A wide range of cone angles may be used although cone angles of seven and one-half degrees can be employed herein. The friction surfaces or friction members may comprise a number of friction materials affixed to a base member.

In a generic sense, the transmission 5 can include not just two gearwheels, but it can include one or more gearwheels with corresponding synchronizer mechanisms. The synchronizer mechanism 15 can be of double-acting type that is designed for mechanically engaging two gearwheels or it can be of a single-acting type that is designed for mechanically engaging one gearwheel.

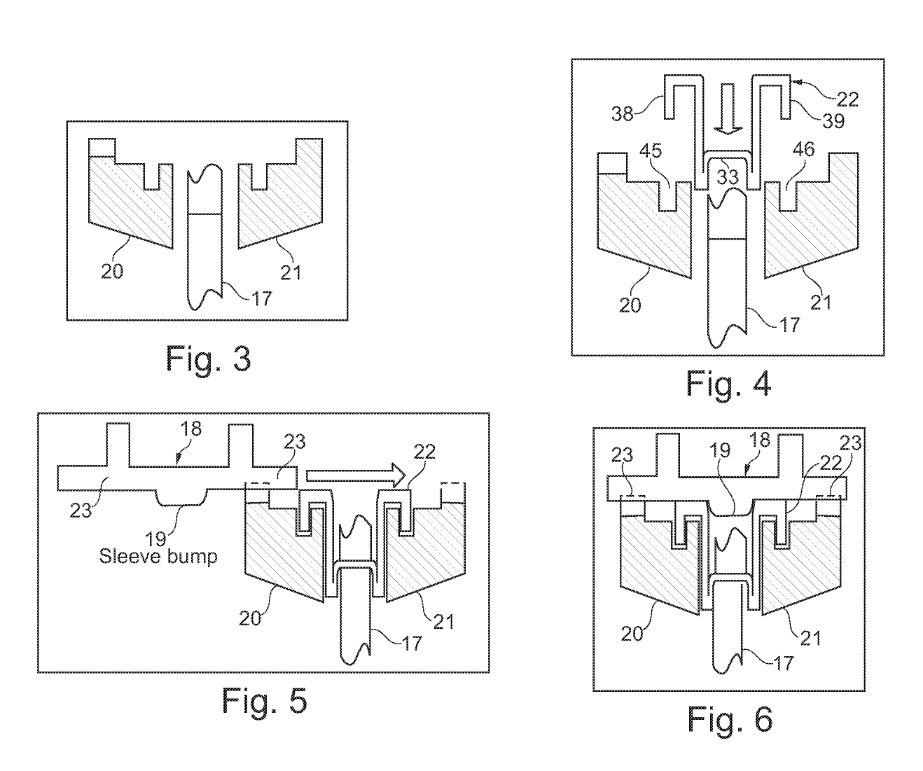

One possible method of assembling or of installing the synchronizer mechanism 15 onto the shaft 11 is shown in FIG. 3 to FIG. 6. The assembly includes a step of fixing the synchronizer hub 17 to the driving shaft 11, as illustrated in FIG. 3. Then, the synchronizer rings 20 and 21 are positioned on the shaft 11 and on opposite sides of the synchronizer hub 17.

The u-shaped section 33 of the synchronizer key 22 is afterward positioned on the synchronizer hub 17, as illustrated in FIG. 4. The positioning also places the claw 38 of the synchronizer key 22 in the groove 45 of the first synchronizer ring 20 and the claw 39 of the synchronizer key 22 in the groove 46 of the second synchronizer ring 21.

The synchronizer sleeve 18 then slides over the synchronizer key 22, as illustrated in FIG. 5. The sliding is such that sleeve splines are placed adjacent to slots of the synchronizer hub 17 and are placed adjacent to slots the synchronizer rings 20 and 21.

After this, the sleeve-bump 19 of the synchronizer sleeve 18 is positioned next to the claws 38 and 39 of the synchronizer key 22 such that the sleeve recess 37 of the synchronizer sleeve 18 compresses the said claws 38 and 39, as illustrated in FIG. 6.

One possible method of transmitting torque from the driving shaft 11 to the gearwheel 12 or 13 comprises a step of a user moving a shift lever to actuate the rotating synchronizer sleeve 18 in a pre-determined axial direction of the shaft 11.

The synchronizer sleeve 18 then abuts against the synchronizer key 22 to push or to urge the selected synchronizer ring 20 or 21 towards the associated cone portion 25 or 26. In effect, the synchronizer key 22 transfers a contact force of the synchronizer sleeve 18 via the synchronizer key 22 onto the respective synchronizer ring 20 or 21.

The inner tapered peripheral surface of the respective synchronizer ring 20 or 21 later forcedly engages against the associated cone portion 25 or 26 as a mating or engaging member. This frictional engagement forces the associated cone portion 25 or 26 to rotate at the same speed as the engaging synchronizer ring 20 or 21.

The speed synchronization also forces the corresponding dog clutch 28 or 29 as well as the corresponding gearwheel 12 or 13 to rotate also at the same speed as the engaging synchronizer ring 20 or 21. This enables the synchronizer mechanism 15 to interlock smoothly with the said dog clutch 28 or 29 without grinding or clashing.

When the interlocking is later not required, the synchronizer sleeve 18 is moved away from the interlocked gearwheel 12 or 13. This also forces the synchronizer key 22 to move in the said direction, which in turn urges the corresponding synchronizer ring 20 or 21 to move also in the same direction.

This is different from other synchronizer key that does not hold the associated synchronizer ring to urge the associated synchronizer ring away from an engaged gearwheel and let the associated synchronizer ring drag or rub on the engaged gearwheel during the disengagement from the said gearwheel and thus introduces wear of the synchronizer ring. The improved synchronizer key 22 has benefits of preventing this dragging. The engaged synchronizer ring 20 or 21 thus has low loss or reduced.

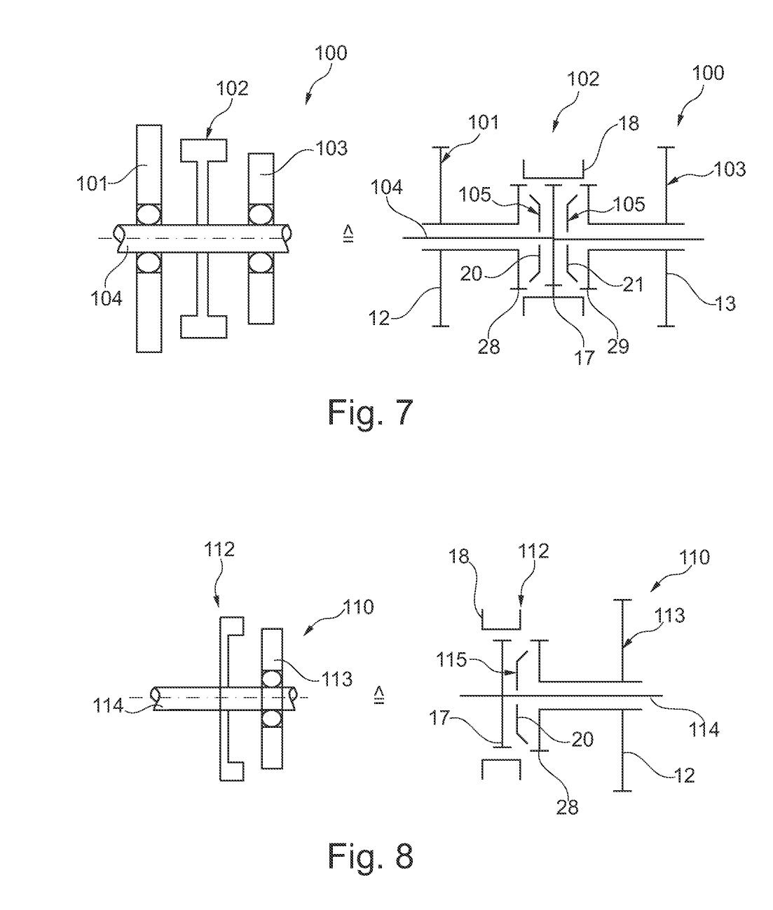

FIG. 7 shows a double-sided coupling device 100. The coupling device 100 includes idler gears 101 and 103, which are connected rotatably to a shaft 104. The idler gears 101 and 103 are also called idler gearwheels. The idler gears 101 and 103 can be brought alternatively into non-rotating engagement with the shaft 104 by means of a shifting mechanism 102. Symbols for the shifting mechanism 102, the idler gears 101 and 103, and the shifting mechanism 102 are shown in closer detail on the right side of FIG. 7.

The shifting mechanism 102 comprises a double-sided synchronizer component 105 and corresponding dog clutches 28 and 29 of the gearwheels 12 and 13 of FIG. 1. The gears 101 and 103 include the gearwheels 12 and 13. The synchronizer component 105 includes the synchronizer sleeve 18, the synchronizer key 22, the synchronizer rings 20 and 21, and the synchronizer hub 17 of FIG. 1. The synchronizer key 22 is not shown in FIG. 7.

FIG. 8 shows a single-sided coupling device 110. The single-sided coupling device 110 comprises an idler gear 113, which is connected rotatably to a shaft 114. The idler gear 113 can be brought alternatively into non-rotating engagement with the shaft 114 by means of a single-sided shifting mechanism 112. Symbols for such shifting mechanism 112, the idler gear 101, and the shifting mechanism 112 are shown in closer detail on the right side of FIG. 8.

The shifting mechanism 112 includes a single-sided synchronizer component 115 and corresponding dog clutch 28 of the gearwheel 12 of FIG. 1. The gear 113 includes the gearwheel 12. The synchronizer component 115 includes the synchronizer sleeve 18, the synchronizer key 22 and the synchronizer ring 20, and the synchronizer hub 17 of FIG. 1. The synchronizer key 22 is not shown in FIG. 8.

FIG. 9 shows symbols for an idler gear 121, which is supported rotatably on a shaft 122 via bearing 123.

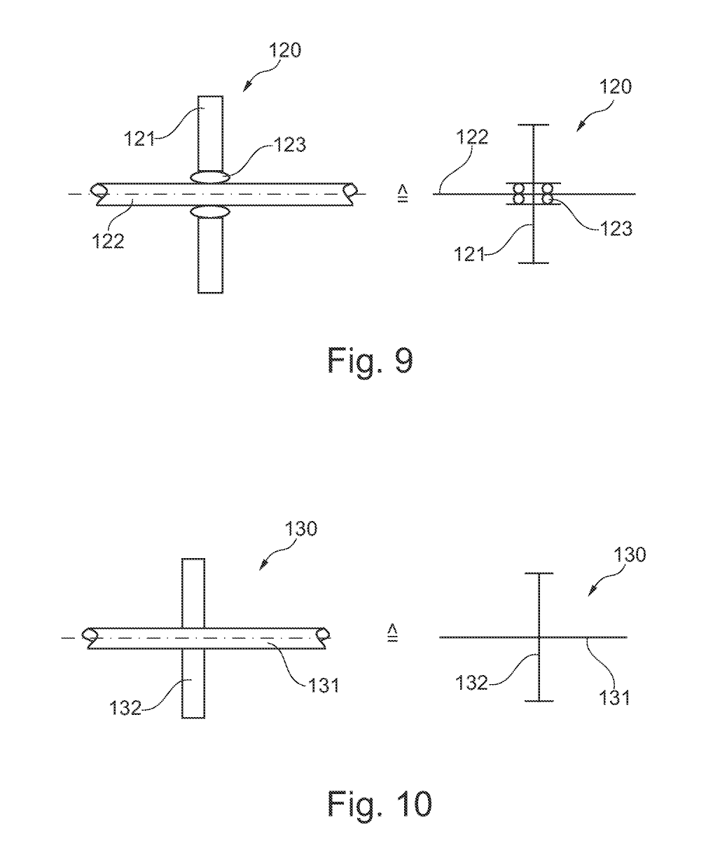

FIG. 10 shows a fixed gearwheel 132 that is connected rigidly to an input shaft 131. A symbol as used in the drawings for such a fixed gearwheel is provided on the left side in FIG. 10. The more commonly used symbol for such a fixed gearwheel is provided on the right side in FIG. 10.

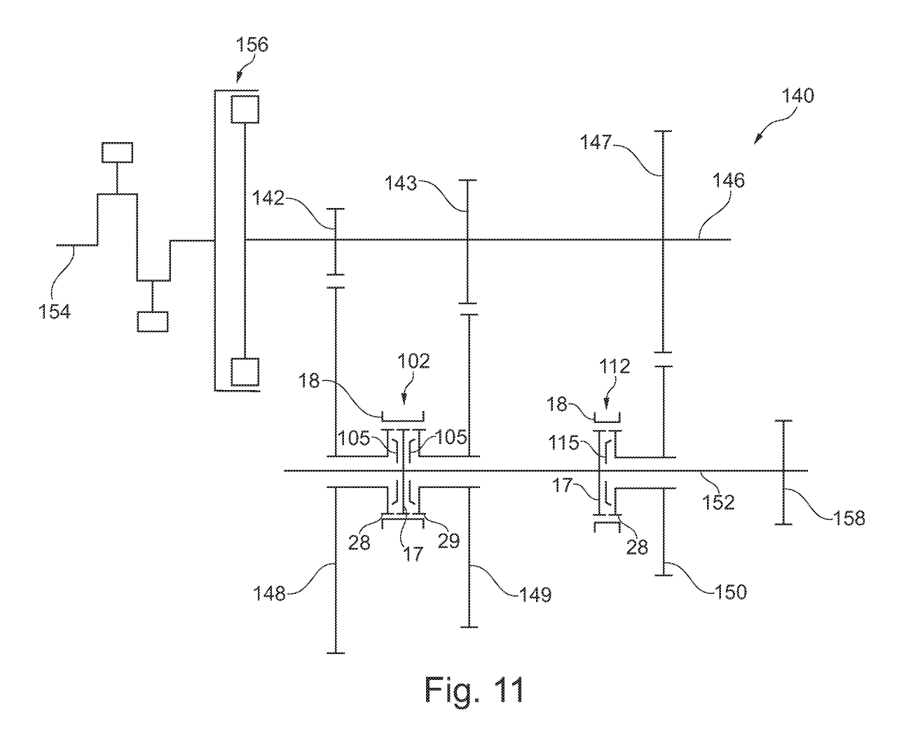

FIG. 11 shows one embodiment of a powertrain 140 for a vehicle that comprises the improved synchronizer of FIG. 1.

The powertrain 140 includes a plurality of input fixed gearwheels 142, 143, and 144 that are provided on an input shaft 146 and a plurality of output idler gearwheels 148, 149, and 150 that are provided on an output shaft 152. The input shaft selectively connects to a crankshaft 154 of a combustion engine by way a clutch 156 whilst the output shaft 152 has an output pinion 158 for connecting to driving wheels of the vehicle.

The input gearwheels 142, 143, and 144 are mounted fixedly on the input shaft 146. In contrast, the output gearwheels 148, 149, and 150 are mounted rotatably to the output shaft 152. Each of the input gearwheels 142, 143, and 144 meshes always with the corresponding output gearwheels 148, 149, and 150 to form gearwheel pairs.

In addition, the powertrain 140 includes the double-sided shifting mechanism 102 of FIG. 7 and the single-sided shifting mechanism 112 of FIG. 8. The shifting mechanisms 102 and 112 are provided in the output shaft 152.

The shifting mechanism 102 includes the synchronizer 105 for selectively engaging one of the gearwheels 148 and 149 to the output shaft 152. Moreover, the shifting mechanism 102 comprises dog clutches 28 and 29 for interlocking the respective gearwheels 148 and 149 to the output shaft 152. Similarly, the shifting mechanism 112 includes the synchronizer 115 for selectively engaging the gearwheel 150 to the output shaft 152 and a dog clutch for interlocking the engaged gearwheel 150 to the output shaft 152.

The above selective interlocking enables rotational forces of the engine to be transmitted via the clutch 156 to the input shaft 146, to the output shaft 152 and to the output pinion 158. The selective interlocking also provides different gear ratios for the powertrain 140.

Although the above description contains much specificity, these should not be construed as limiting the scope of the embodiments but merely providing illustration of the foreseeable embodiments. Especially the above stated advantages of the embodiments should not be construed as limiting the scope of the embodiments but merely to explain possible achievements if the described embodiments are put into practice. Thus, the scope of the embodiments should be determined by the claims and their equivalents, rather than by the examples given. Moreover, while at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A synchronizer assembly for a gearbox of a power train of a vehicle, comprising:
a synchronizer hub adapted to engage with a shaft of the gearbox;
an axially movable synchronizer ring comprising a synchronizer frictional surface adapted to frictionally engage with a gearwheel frictional surface of a gearwheel of the gearbox;
an axially movable synchronizer sleeve adapted to engage with the synchronizer hub and with a synchronizer ring; and
a synchronizer key arranged between the synchronizer hub and a synchronizer sleeve, the synchronizer key comprising a release member adapted to engage the synchronizer ring in an axial direction such that the synchronizer ring is movable away from the gearwheel frictional surface of the gearwheel of the gearbox.

2. The synchronizer assembly of claim 1, wherein the synchronizer sleeve comprises a bump adapted to actuate the synchronizer ring via the synchronizer key to engage with the gearwheel.

3. The synchronizer assembly of claim 1, wherein the synchronizer sleeve comprises splines adapted to engage with the synchronizer hub and the synchronizer ring.

4. The synchronizer assembly of claim 1, wherein a holding member comprises a spring section adapted to urge the synchronizer ring away from the gearwheel during a disengagement of the synchronizer ring from the gearwheel.

5. The synchronizer assembly of claim 4, wherein the spring section comprises a claw portion retained by a groove of the synchronizer ring.

6. The synchronizer assembly of claim 4, wherein the spring section comprises a middle portion adapted to dispose on the synchronizer hub.

7. The synchronizer assembly of claim 4, wherein the spring section comprises a punched portion.

8. The synchronizer assembly of claim 1, wherein the synchronizer ring is adapted for frictional engagement with the gearwheel.

9. The synchronizer assembly of claim 1, further comprising two synchronizer rings adapted for frictional engagement with the gearwheel and a second gearwheel.

10. The synchronizer assembly of claim 1, wherein the synchronizer hub is substantially fixed to the shaft via splines such that the synchronizer hub is slidable in the axial direction of the shaft.

11. A shifting mechanism for a transmission, comprising:
a synchronizer assembly, comprising:
a synchronizer hub adapted to engage with a shaft of a gearbox;
an axially movable synchronizer ring comprising a synchronizer frictional surface adapted to frictionally engage with a gearwheel frictional surface of a gearwheel of the gearbox;
an axially movable synchronizer sleeve adapted to engage with the synchronizer hub and with a synchronizer ring; and
a synchronizer key arranged between the synchronizer hub and a synchronizer sleeve, the synchronizer key comprising a release member adapted to engage the synchronizer ring in an axial direction such that the synchronizer ring is movable away from the gearwheel frictional surface of the gearwheel of the gearbox; and
the gearwheel comprising at least one clutch adapted for interlocking the gearwheel to a shaft of the transmission after a first rotational speed of the gearwheel is synchronized with a second rotational speed of the shaft.

12. The shifting mechanism of claim 11, wherein the synchronizer sleeve comprises a bump adapted to actuate the synchronizer ring via the synchronizer key to engage with the gearwheel.

13. The shifting mechanism of claim 11, wherein the synchronizer sleeve comprises splines adapted to engage with the synchronizer hub and the synchronizer ring.

14. The shifting mechanism of claim 11, wherein a holding member comprises a spring section adapted to urge the synchronizer ring away from the gearwheel during a disengagement of the synchronizer ring from the gearwheel.

15. The shifting mechanism of claim 14, wherein the spring section comprises a claw portion retained by a groove of the synchronizer ring.

16. The shifting mechanism of claim 14, wherein the spring section comprises a middle portion adapted to dispose on the synchronizer hub.

17. The shifting mechanism of claim 14, wherein the spring section comprises a punched portion.

18. The shifting mechanism of claim 11, further comprising one synchronizer ring adapted for frictional engagement with the gearwheel.

19. The shifting mechanism of claim 11, further comprising two synchronizer rings adapted for frictional engagement with the gearwheel and a second gearwheel.

20. The shifting mechanism of claim 11, wherein the synchronizer hub is substantially fixed to the shaft via splines such that the synchronizer hub is slidable in the axial direction of the shaft.

21. A transmission for an engine of a vehicle, comprising:
a driving shaft adapted to connect with a powertrain section of the vehicle,
a driving gearwheel rotatably mounted on the driving shaft; and
a shifting mechanism mounted on the driving shaft and adapted for selectively engaging the driving gearwheel with the driving shaft, the shifting mechanism comprising:
a synchronizer hub adapted to engage with a shaft of a gearbox;
an axially movable synchronizer ring comprising a synchronizer frictional surface adapted to frictionally engage with a gearwheel frictional surface of a gearwheel of the gearbox;
an axially movable synchronizer sleeve adapted to engage with the synchronizer hub and with a synchronizer ring; and
a synchronizer key arranged between the synchronizer hub and a synchronizer sleeve, the synchronizer key comprising a release member adapted to engage the synchronizer ring in an axial direction such that the synchronizer ring is movable away from the gearwheel frictional surface of the gearwheel of the gearbox; and
the gearwheel comprising at least one clutch adapted for interlocking the gearwheel to a shaft of the transmission after a first rotational speed of the gearwheel is synchronized with a second rotational speed of the shaft.

22. The transmission of claim 21, further comprising:
a input shaft adapted to engage with the engine of the vehicle; and
an input gearwheel fixedly mounted on the input shaft, the input gearwheel adapted to mesh with the driving gearwheel.
